(19) United States
(12) Patent Application Publication
(10) Pub. No.: US 2008/0149700 A1
(43) Pub. Date: Jun. 26, 2008

(54) Speckle Pattern For Authenticating An Information Carrier

(75) Inventors: Pim Theo Tuyls, Eindhoven (NL); Robert Frans Maria Hendriks, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,066

(22) PCT Filed: Feb. 16, 2005
(86) PCT No.: PCT/IB2005/050583

§ 371 Date: Aug. 17, 2006

(30) Foreign Application Priority Data
Feb. 24, 2004 (EP) 04100710.5

(51) Int. Cl. G06F 17/00

(52) U.S. Cl. 235/375

(57) ABSTRACT

The invention relates to a system comprising an information carrier 11 having an optical identifier 12, and an apparatus 10, wherein the apparatus prior to accessing the information carrier verifies if the optical behavior of the optical identifier is consistent with authentication information 17 present in the information carrier. The authentication is performed by challenging the optical identifier with a least one light beam 14, detecting a resulting speckle pattern 16 on a detector 15 as a corresponding response, and comparing it with the authentication information 17. Access to the information carrier can be made conditional to a successful authentication, in particular by encrypting user-information 20 present in the information carrier, and thereby providing a strong copy protection scheme. The invention can be applied for example to optical disks or smart cards. The invention further relates to the information carrier, the apparatus, a method for the authentication and a computer program.

The invention relates to a system comprising an information carrier and an apparatus for accessing the information carrier.

The invention further relates to the information carrier, to the apparatus for accessing the information carrier, to a method for accessing the information carrier, and to a computer program implementing the method.

An embodiment of a system comprising an information carrier and an apparatus for accessing the information carrier is known from the article “Physical one-way Functions”, Ravikanth Pappu et al., Vol. 297 SCIENCE 20/09/2002, pages 2026-2030. According to this article, a token of substantially transparent inhomogeneous material, e.g. epoxy containing glass spheres, air bubbles or any kind of scattering particles, can be irradiated so as to produce a speckle pattern which depends on both the internal microstructure of the token and on the incident radiation.

Such a token, called hereinafter ‘optical identifier’, represents a physical one-way function, and it is prohibitively difficult to clone, either in a physical way or in the sense of building a mathematical model of it. Moreover, since the irradiating light beam incident on the optical identifier, i.e. the challenge, can be varied so as to produce a large plurality of corresponding speckle patterns, i.e. responses, also an input-output modeling of the optical identifier can be made impervious. Due to these features, a possible application can be the authentication of credit cards. Initially, a credit card having such an optical identifier, which is unique, is enrolled at a secure terminal, by challenging the optical identifier with a set of challenges, detecting the corresponding responses, and sending the challenges and the corresponding responses to a server for being stored in a database. Then, the credit card be can authenticated when inserted in an insecure terminal connected to the server, by challenging the optical identifier with a challenge present in the database, detecting the response and verifying if it matches with the corresponding response stored.

It is a disadvantage of the known system that the information carrier can only be authenticated when the terminal is connected to the server, and therefore not in a stand-alone configuration.

It is a first object of the invention to provide a system comprising an information carrier and an apparatus for accessing the information carrier, which allows for the authentication of the information carrier to be carried out in a stand-alone configuration.

It is a second object of the invention to provide an information carrier which allows for its authentication by an apparatus for its access in a stand-alone configuration.

It is a third object of the invention to provide an apparatus for accessing an information carrier, which allows for the authentication of the information carrier in a stand-alone configuration.

It is a fourth object of the invention to provide a method for accessing an information carrier, in which the information carrier is authenticated without resorting to external information, and a computer program implementing the method.

According to the invention, the first object is achieved by a system having the features of claim 1.

Since in the system according to the invention the authentication information is present in the information carrier, the apparatus for accessing the information carrier can authenticate the information carrier, i.e. assess whether the information carrier is authentic, by comparing the response obtained upon challenging the optical identifier and the authentication information read from in the information carrier, without resorting to external information, and therefore in a stand-alone configuration. The comparison between the response obtained and the authentication information is an assessment of the authenticity in the sense that a match between the two is an indication that the information carrier is authentic, since a normal user has no means to create or modify in a controlled way the optical identifier nor to determine and record the authentication information.

The authentication information present in the information carrier does not need to comprise an exact copy of the response, but rather the result of a mathematical function applied to the challenge, which mathematical function can be public or a secret shared between the apparatus and the producer of the information carrier. In this case the verification unit applies the mathematical function to the response obtained and compares it with the result present in the authentication information. Preferably, in order to further strengthen the security of a such system, the mathematical function applied to the response is a one-way function, for example a hash one-way function or a cryptographic one-way function, so that even when having the knowledge of the one-way function used, it is unfeasible to reconstruct the response from the result of the one-way function applied to it.

In an advantageous embodiment, the system according to the invention has the features of claim 2, in which case the decryption unit also performs the function of a conditional access unit. This embodiment has the strong advantage that a bit-by-bit copy of the user-information encrypted to a second information carrier, not having an optical identifier at all or having a different optical identifier, would result in the second information carrier to have non-accessible user-information, because the apparatus while challenging the second information carrier would not be able to detect the response necessary to extract the decryption key. Moreover, encryption of the user-information represents also an effective defense from an access by a non-compliant apparatus, i.e. an apparatus trying to access user-information present on the information carrier even when the information carrier is found to be not authentic.

In a further embodiment the system according to the invention has the features of claim 3. In this case the apparatus is able to provide a set of challenges, each challenge giving rise to a corresponding response, and the authentication information is further related to the corresponding responses. The set of challenges can be seen as the space of challenges the apparatus is able to provide for challenging the optical identifier, and to which corresponding responses the authentication information is related.

The system having the features of claim 3 may further have the characterizing features of claim 4. In this case during an authentication phase only a subset of the set of challenges, with which the apparatus can challenge the optical identifier, is actually used for challenging the optical identifier, detecting the corresponding response and comparing them with the authentication information.

In this embodiment a degree of freedom is introduced in the way the authentication is carried out. The set of challenges may comprise from hundreds to thousands of challenges, or even more, while the subset of challenges used during an authentication phase may be significantly smaller, typically a few challenges or even a single challenge. Preferably the subset has to be chosen in a way that the challenges used in an authentication phase are not likely to be repeated in a subsequent authentication phase, so that an attacker has no incentive from trying to learn the responses to used challenges, because these are not likely to be repeated. The subset of challenges for example can be selected randomly by the apparatus from the set of challenges.

The system having the features of claim 3 may also have the characterizing features of claim 5. The authentication information may for example contain indication of what challenges belong to the set of challenges, and to which corresponding responses the authentication information is therefore related, i.e. with what challenges the apparatus can challenge the optical identifier.

The system having the features of claim 5 may further have the characterizing features of claim 6, in which case the authentication information has the form of a table having a record for each challenge belonging to the set of different challenges, the record having in a first field the result of a first one-way function applied to the each challenge, and in a second field the result of a second one-way function applied to the corresponding response.

The system having the features of claim 6 may further have the characterizing features of claim 7, according to which the verification unit is able to verify for an individual challenge if the result of a one-way function applied corresponding responses matches a value present in a record relevant to that challenge.

The light source to generate the challenges can be for example a laser which is able to produce a light beam having a wavelength, a wavefront, an angle of incidence and an area of incidence on the optical identifier.

Different challenges can be generated for example with an apparatus wherein the laser is controllable to vary at least one of the wavelength and the wavefront. In alternative or in addition the apparatus may comprise means to orient the laser so to vary at least one of the angle of incidence and the area of incidence on the optical identifier.

Different challenges can be further generated with an apparatus comprising a Spatial Light Modulator (SLM) for spatially modulating the light beam. The SLM consists of an array of transparent/dark pixels deciding which part of the laser beam is transmitted or blocked, respectively. Alternatively, an SLM can consist of an array of phase-changing pixels, or of an array of micro-mirrors.

In an even further embodiment the system according to the invention has the features of claim 8. In this way it is possible to verify if the time elapsed between challenging the optical identifier and detecting the speckle pattern, i.e. the response time, corresponds to an expected value or is in an expected range, and to grant access to the information-carrier only if this condition is respected. This represents a further precaution against attempts to fool the system, since it is expected that such attempts would possibly result in a response time different from the one elapsing when genuinely detecting a response. It has to be outlined that the response time is not simply the time required for the light beam generated by the light source to physically arrive to the detector, but the time for the speckle pattern to be acquired by the detector with sufficient clarity, in a similar way to how an image is acquired by a digital camera. This time primarily depends on the intensity of the received light, besides on the sensitivity and other features of the detector.

According to the invention, the second object is achieved by an information carrier as claimed in claim 9 and 10, the third object is achieved by an apparatus as claimed in claim 11, and the fourth object is achieved by a method as claimed in claim 12 and a computer program as claimed in claim 13, as it will appear clear from the foregoing discussion.

These and other aspects of the system, information carrier, apparatus and method according to the invention will be further elucidated and described with reference to the drawings. In the drawings:

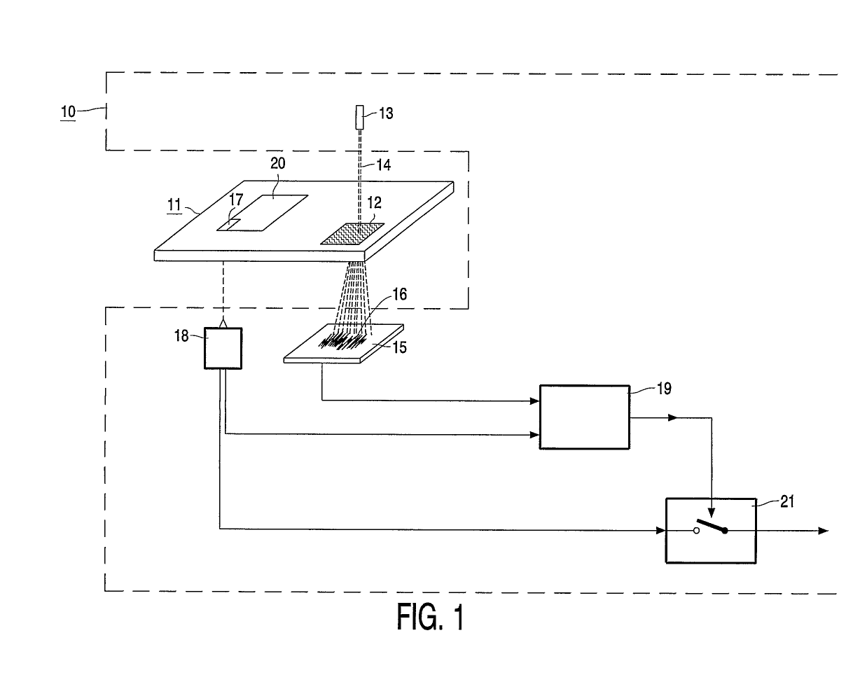

FIG. 1 shows a first embodiment of the system according to the invention,

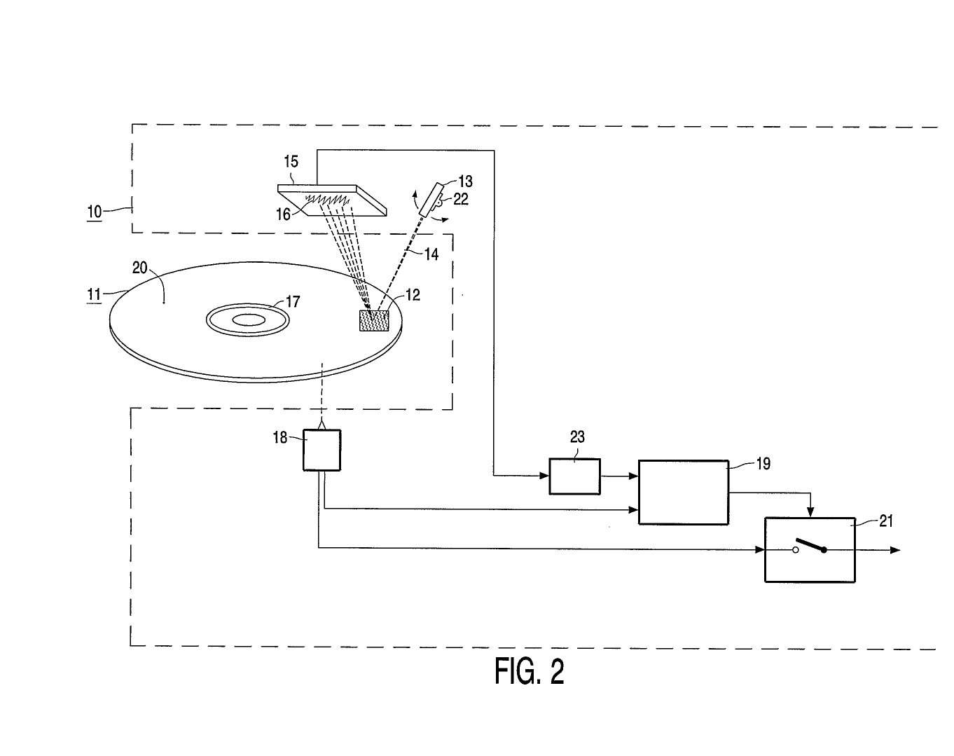

FIG. 2 shows a second embodiment of the system according to the invention,

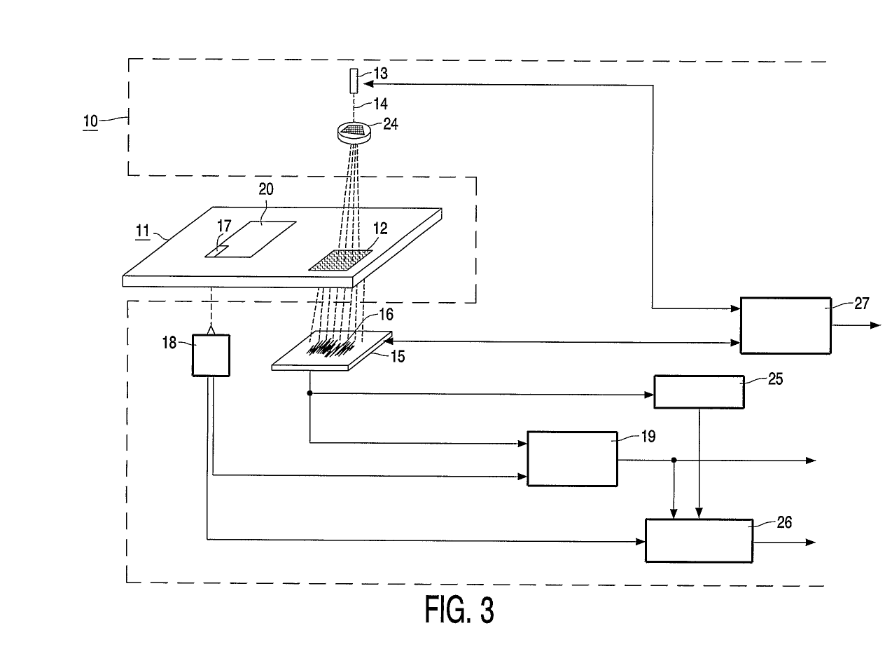

FIG. 3 shows a third embodiment of the system according to the invention,

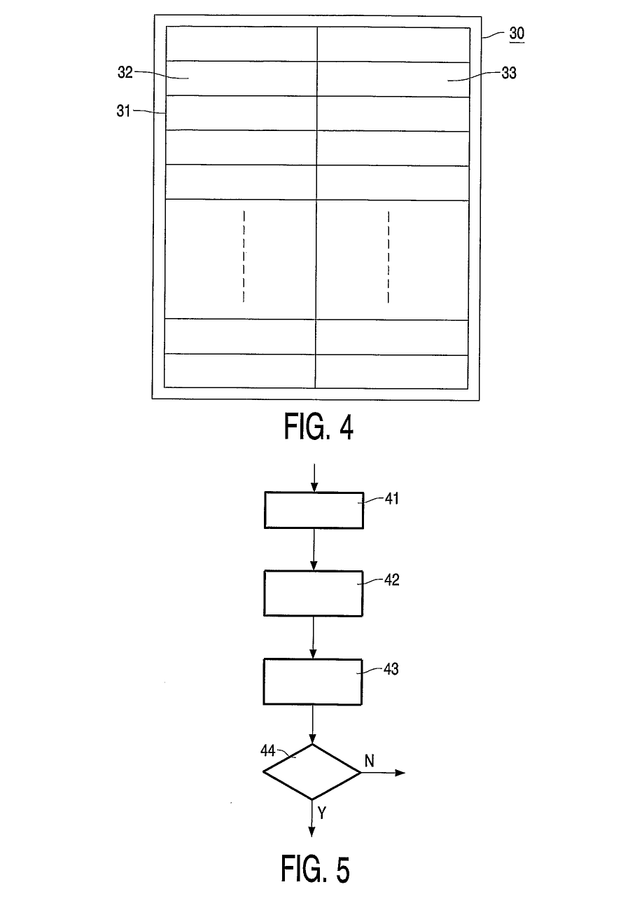

FIG. 4 shows the authentication information, in the form of a table,

FIG. 5 shows a first embodiment of the method according to the invention, and

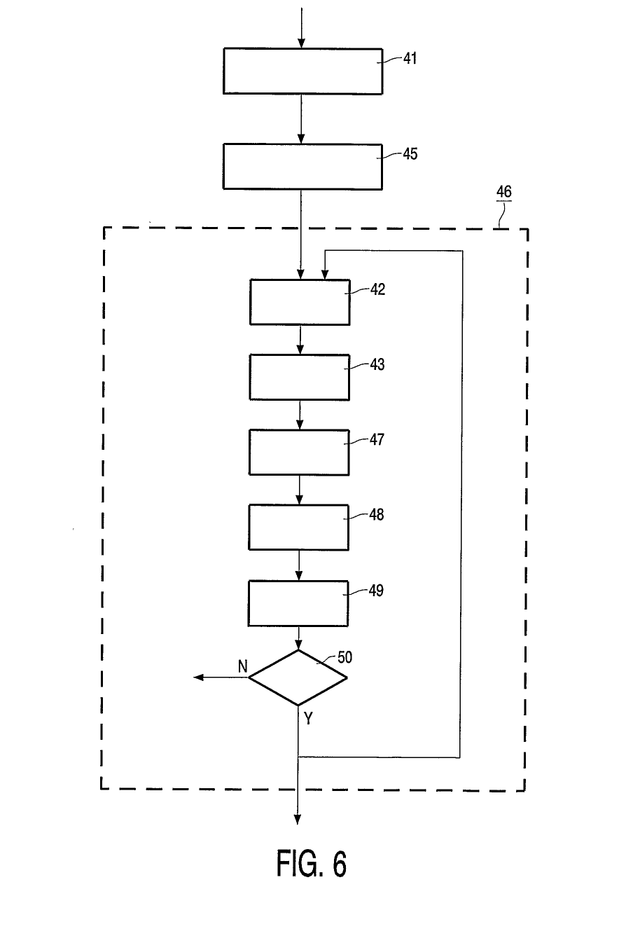

FIG. 6 shows a second embodiment of the method according to the invention.

In FIG. 1, which shows a first embodiment of the system according to the invention, it is possible to see an information carrier 11 for comprising user-information 20, having an optical identifier 12, and an apparatus 10 for accessing the information carrier 11. The apparatus 10 comprises a light source 13 for challenging the optical identifier 12, when the information carrier 11 is present in the apparatus 10, by generating a light beam 14 incident on the optical identifier 12 as a challenge, a detector 15 for detecting as response a speckle pattern 16 produced by the optical identifier 12 upon being challenged with the light beam 14, and a reading unit 18 for acquiring the user-information 20. The information carrier 11 further comprises authentication information 17, which is related to the response, and which is also acquired by the apparatus 10 by means of the reading unit 18. A verification unit 19 compares the response with the authentication information 17, and according to if there is matching or not, assesses whether the information carrier 11 is authentic or not. The comparison made by the verification unit must not be intended as a mere comparison of two values, but may involve for example the processing of at least one of the response and the authentication information, before a comparison strictly speaking takes place.

Such a system can be in place for any type of information carrier for which it is important to assess whether the information carrier and/or the user-information 20 contained therein hasn't been counterfeited: therefore for example smart cards such as credit cards, bank cards, client cards, or information carriers for copy protected content like for example optical disks for containing music or movies such as CDs or DVDs.

The information carrier may also be an information carrier recordable by the user similar to a CD-R or a CD-RW, in view of the system allowing controlled copy of copy protected material, possibly in exchange of levies incorporated in the price of the blank recordable information carrier.

The assessment made by the verification unit 19 whether the information carrier 11 is authentic or not can be exploited by a conditional access unit 21 which, only on condition that it has been assessed that the information carrier is authentic, grants access to the user-information 20 present on the information carrier 11, for example enables its playback, or, in case the information carrier 11 is a recordable information carrier, enables a read/write access. As an alternative to the conditional access unit 21 a warning message can be generated, or the information on the authenticity of the information carrier 11 can simply be stored for a later use.

It is also possible that only a part of the user-information is subject to conditional access whereas free unconditional access is foreseen for the remaining user-information. If the information carrier 11 is intended for allowing the holder to perform certain operations, e.g. withdrawal of money from a bank account, the conditional access unit 21 enables such operations.

The user-information 20 for which the information carrier 11 is intended may be for example an audio recording, a movie, a computer program, or, especially in case of a smart card, details of the card holder or a card identification number, to enable the card holder to perform certain operations.

In the drawing it is shown that both the user-information 20 and the authentication information 17 are read by an integral reading unit 18, however it is also possible for the reading unit 18 to be formed by two distinct sub-units, one for the user-information 20 and the other for the authentication information 17, the two distinct sub-units possibly involving different signal processing or even different optical, electrical or mechanical components.

The authentication information 17 present in the information carrier 11 does not need to comprise an exact copy of the response, but rather the result of a mathematical function applied to the challenge, the mathematical function being preferably a secret shared between the apparatus 10 and the producer of the information carrier 11. In this case the verification unit 19 operates the comparison after a computational unit has applied the mathematical function to the response obtained. Preferably, in order to further strengthen the security of a such system, the mathematical function is a one-way function.

The authentication information 17 may be related only to the response, i.e. independent of any other data present on the information carrier 11, and in particular of the user-information 20, or it may be further related to other data present on the information carrier 11. For example, if the information carrier is a smart card containing personal details of the holder, the authentication information 17 may be a cryptographic summary of the personal details and of the response.

The authentication information 17 present in the information carrier 11 can be prerecorded thereon after having been initially determined during an enrollment phase by challenging the optical identifier 12 with the challenge, detecting the response, and if applicable applying the one-way function to the response.

The authentication information 17 may occupy a predefined section of the storage space which is also designed to contain the user-information 20, preferably is a section where no interference with any user-access may occur and even more preferably it is dealt with in a way that makes it completely invisible to the user, which section, in case of an optical disk, could be represented by a section in the lead-in or in the lead-out area. As an alternative the authentication information 17 may be stored in a secondary storage space associated to a secondary channel in the information carrier, which, in case of an optical disk, could be represented by the wobble channel, i.e. a channel of information embedded in the radial modulation of a spiral track.

The optical identifier 12 may consist of a token, for example having circular or rectangular shape, of a substantially transparent inhomogeneous material, e.g. epoxy containing glass spheres, air bubbles or any kind of scattering particles, that can be irradiated so as to produce a speckle pattern which depends on both the irradiation and the internal microstructure. Such an identifier is commonly the result of an uncontrolled process, implying that two optical identifiers are inevitably different, therefore giving rise to different responses and different authentication informations, so that each information carrier has a possibly different and unique authentication information. This consequence may be acceptable for a smart card wherein personal details are stored, because the information to be stored is also unique and therefore the fact that the authentication information 17 is unique does not significantly add complexity to the process of storing the overall information, personal details and authentication information. The same consequence instead may be unacceptable for pressed optical disks, wherein the content, e.g. music, a movie, or software, has to be replicated on the large number of optical disks: in this case in fact the presence of a section of information, the authentication information, different from disk to disk, would make the storing process very complex.

Interestingly, non pre-published European Patent Application 03103800.3 by the same Applicant (NL 031268) discloses a method for producing a plurality of information carriers having equal optical identifiers by means of a stamp obtained with an uncontrolled process, wherein the stamp is used in a controlled way to imprint a printable material so as to obtain equal optical identifiers. In combination with this technique the invention can conveniently be applied to a system wherein the information carrier is a pressed optical disk. An alternative way to implement an optical identifier 12 may be a hologram.

The detector 15 may be positioned facing the same side of the information carrier 11 as the light source 13 or on an opposite side. The light source 13 and the detector 15 can be positioned in various ways, having care only that in presence of the information carrier 11 the light beam 14 generated by the light source 13 irradiates the optical identifier 12 and that the detector 15 captures a speckle pattern 16 deriving from the interaction of the light beam 14 with the optical identifier 12. The position of the light source 13 and of the detector 15 in respect with the optical identifier 12 however has to be fixed and precisely reproduced in all apparatuses 10 of the kind, designed for accessing the information carrier 11, in order to consistently obtain the same response to the challenge.

The speckle pattern 16, or light pattern, which is formed on the detector 15 as a result of the optical identifier 12 being irradiated with a light beam 14 depends on both the features of the incident light beam 14 and of the internal microstructure of the optical identifier 12, as a result of optical phenomena like e.g. reflection, refraction, diffraction taking place inside the optical identifier 12. A small change in the microstructure would result in a different speckle pattern. Moreover the analysis of the speckle pattern 16 does not allow to deduce the internal microstructure of the optical identifier by means of calculations even when knowing the features of the light beam 14. Therefore the optical identifier 12 irradiated with a light beam 14 represents a physical one-way function which input are the internal microstructure and the light beam 14 and which output is the speckle pattern 16. The nature of the optical identifier 12 and the way it is the dealt with within the system make the optical identifier 12 substantially impossible to clone, as it is explained in detail in the “SCIENCE” article cited above.

Due to the unclonability of the optical identifier 12, with the system according to the invention counterfeited information carriers can be identified and their use by compliant apparatuses can be prevented. For example, access to the content of counterfeited optical disks can be blocked in a compliant playback device.

In an advantageous embodiment the user-information 20 present on the information carrier 11 is encrypted. The decryption key can be extracted by a decryption key extraction unit present in the apparatus 10 from the response. The key extracted is then used by a decryption unit for decrypting the user-information encrypted. In the simplest implementation a symmetrical encryption algorithm can be used, and the encryption/decryption key is determined, along with the authentication information 17 during the enrollment phase, after which the user-information 20 is encrypted and then stored in the information carrier 11.

This embodiment has the strong advantage that a bit-by-bit copy of the encrypted user-information in a second information carrier, not having an optical identifier or having a counterfeited, and therefore different, optical identifier, would not be accessible even by a non-compliant apparatus.

This system can be further strengthened with techniques known in the art like for example, in case of audio or video content, rendering the content only in an analog form outside a secure environment, e.g. a chip where the encrypted user-information is decrypted, or with the embedding of a watermark carrying Copy Control Information in the user- information 20.

FIG. 2 shows a second embodiment of the system according to the invention. The light source 13 is a laser which is able to produce a light beam 14 having a wavelength, a wavefront, an angle of incidence and an area of incidence on the optical identifier 12. The wavefront is a surface connecting all points having equal phase, e.g. for a plane wave it is a plane, for a diverging wave it can be a sphere, and any other surface profiles are possible, according to the directions the light propagates along.

The laser is controllable to vary wavelength and/or wavefront of the generated light beam 14, so that a set of different challenges can be generated for challenging the optical identifier 12. The number of challenges that can be generated can be further augmented by varying the angle of incidence and/or the area of incidence on the optical identifier 12 of the light beam 14 by acting on orientation means 22 present in the apparatus 10 and supporting the laser. The orientation means 22 allow the laser to be oriented with a variable angle in respect with a reference orientation within a range selected in a way so that the light beam 14 is still incident on the optical identifier 12.

Therefore the apparatus 10 is able to provide a set of challenges, and, for each individual challenge with which the optical identifier 12 is challenged, to detect a corresponding response. The authentication information 17 is related to the corresponding responses, and may contain for example for each or for some of the challenges belonging to the set of challenges the result of a one-way function applied to the corresponding response. The verification unit 19 compares the authentication information 17 with the corresponding responses obtained by the apparatus 10, if applicable after a computational unit 23, which can be both internal or external to the verification unit 19, has applied to them a one-way function.

In this case the authentication information 17 is determined during an enrollment phase by challenging the optical identifier 12 with the challenges belonging to the set of challenges and detecting the corresponding responses, in the same manner as it is done by the apparatus 10 for accessing the information carrier 11.

The set of challenges therefore may be fixed and agreed for all the apparatuses 10 and information carriers 11 of the kind. As an alternative an information carrier 11 may have an authentication information 17 related to responses obtainable with an ad hoc set of challenges, smaller than and contained in the set of challenges that can be generated by the apparatus. In this case the authentication information 17 may further contain information indicative of what challenges consists the ad hoc set of challenges with which the apparatus 10 needs to challenge the optical identifier 12 for the authentication.

During an authentication phase, it is generally not necessary to challenge the optical identifier 12 with all the challenges belonging to the set of challenges, since the matching of a few responses or even a single response with the authentication information 17 may already give sufficient confidence on the authenticity of the information carrier 11. Therefore, especially if the set comprises a large number of challenges, for example hundreds or thousands, during the authentication phase the optical identifier 12 can be challenged with a small subset of challenges, comprising only a few units. The subset of challenges is preferably determined so that in a subsequent authentication phase a different subset is employed, for example by randomly selecting the subset out of the set of challenges.

FIG. 3 shows a third embodiment of the system according to the invention. The apparatus 10 is able to provide a set of challenges, in this case due to the presence of an SLM 24 by means of which from a light beam 14 constant a large number of distinct challenges can be generated.

In this embodiment at least part of the user-information 20 is encrypted and the corresponding responses are used not only for the authentication of the information carrier 11 but also by a decryption key extraction unit 25 for extracting a decryption key, necessary to a decryption unit 26 in order to decrypt the user-information 20 encrypted. The user-information 20 encrypted is also read by the reading unit 18 and transferred to a decryption unit 26, where it is decrypted with the decryption key.

If the set comprises a large number of challenges, only a fixed subset of them will be used for extracting the decryption key. Therefore during an authentication phase the optical identifier 12 can be challenged with the fixed subset of challenges necessary for the key extraction, and possibly with an additional subset of challenges, comprising only a few units, for the authentication. However it is also possible to complete skip of the additional subset of challenges since the key extraction of a valid decryption key already represents a form of authentication.

The detection of a speckle pattern consequent to challenging the optical identifier 12 with a challenge requires some time which depends both on the optical identifier 12, for example its absorption of light, and on the apparatus 10, for example the intensity of the light beam 14 generated and the sensitivity of the detector 15. This time belongs to a range, and in particular has a maximum value, which can be assessed by means of calculation and observation in different operating conditions.

A further unit, consisting of means for monitoring the time elapsing 27 between challenging the optical identifier 12 and detecting the speckle pattern 16, is present and generates an alarm signal if this time exceeds a predetermined maximum value or is out of a predetermined range, which alarm signal can be used to hamper access to user-information 20. The presence of such a unit brings a further level of security to the system since an attempt to fool the verification unit 19 by providing to it emulated responses to challenges may be revealed.

FIG. 4 shows the authentication information, in the form of a table 30 wherein each row represents a record 31 relevant to a challenge belonging to the set of challenges. The record 31 has in a first field 32 the result of a first one-way function applied to the challenge, and in a second field 33 the result of a second one-way function applied to the corresponding response.

As introduced with reference to FIG. 2, the table 30 may contain a record 31 limited to challenges belonging to an ad hoc set of challenges, smaller than and contained in the set of challenges. This ad hoc set of challenges may be different from an information carrier to another, and in this case the authentication information 17 may further contain information indicative of what challenges consists the ad hoc set of challenges with which the apparatus 10 needs to challenge the optical identifier 12 for the authentication.

FIG. 5 shows a first embodiment of the method according to the invention. The method can be applied by an apparatus 10 for accessing an information carrier 11 having an optical identifier 12 and authentication information 17, which is related to the response obtained upon challenging the optical identifier 12 with a light beam 14. The method comprises: a reading step 41, a challenging step 42, a detection step 43, and a verification step 44. During the reading step 41 the authentication information 17 is read from the information carrier 11; then, during the challenging step 42 the optical identifier 12 is challenged with the light beam 14, so that a consequent speckle pattern 16, resulting from the optical identifier 12 being irradiated with the light beam 14, can be detected as a response in the consequent detection step 43; last, during the verification step 44 the authentication information 17 and the response are compared allowing for the assessment of whether the information carrier 11 is authentic or not.

If the authentication information 17 comprises the result of a mathematical function, for example a one-way function, applied to the response, then the method further comprises a computation step in which the mathematical function is applied to the response before the verification step 44.

FIG. 6 shows a second embodiment of the method according to the invention, which can be applied by an apparatus 10 capable of generating a set of challenges, for accessing an information carrier 11 having an optical identifier 12 and authentication information 17, which is related to the corresponding responses. The method is suitable in particular for being applied in the case in which the authentication information 17 has the features shown in FIG. 4, and comprises: a reading step 41, a subset determination step 45, and a verification block 46.

In the subset determination step 45 a subset of challenges with which to challenge the optical identifier 12 is determined, for example by selecting randomly or in any other non-repetitive way a few challenges out of the set of challenges; the subset of challenges is then used in the verification block 46 to assess whether the information carrier 11 is authentic or not: each individual challenge belonging to the subset of challenges is used to challenge the optical identifier 12, and it is verified if the corresponding response matches with the authentication information 17 which has been acquired in the reading step 41, and more in particular if the calculated result of a one-way function applied to the corresponding response equals the expected value which is stored in a relevant record 31 of the table 30 representing the authentication information 17.

Therefore, the internal loop of the verification block 46 comprises for the each individual challenge: a challenging step 42, a detection step 43, a first computation step 47, a second computation step 48, a search step 49, and a verification step 50. After the optical identifier 12 has been challenged with the each challenge in the challenging step 42 and the corresponding response has been detected in the detection step 43, in the first computation step 47 and in the second computation step 48 a first and a second one-way function are applied respectively to the challenge and to corresponding response so to obtain a first and a second result. During the search step 49 it is searched in the table 30 a record 31 having in the first field 32 a value equal to the first result, and the value present in the second field 33 of the record 31 identified is read and compared to the second result in the verification step 50. If the comparison results a match, it is checked if all challenges belonging to the subset of challenges have been used, and the internal loop of the verification block 46 is reiterated with one of the remaining challenges or terminated accordingly.

If all the challenges belonging to the subset of challenges have been used and the verification step 50 has always resulted in a match, then the information carrier 11 is considered to be authentic, otherwise, if for any challenge the verification step 50 has resulted in a mismatch, then the information carrier 11 is considered to be not authentic.

Although the invention has been elucidated with reference to a system comprising an information carrier having an optical identifier and an apparatus for its access, wherein the information carrier is an optical disk or a smart card, it will be evident that other embodiments may be alternatively used to achieve the same object. The scope of the invention is therefore not limited to the embodiments described above, but can also be applied to other kinds of information carriers or other kinds of physical one-way functions, even non-optical, as identifiers.

It must further be noted that the term “comprises/comprising” when used in this specification, including the claims, is taken to specify the presence of stated features, integers, steps or components, but does not exclude the presence or addition of one or more other features, integers, steps, components or groups thereof. It must also be noted that the word “a” or “an” preceding an element in a claim does not exclude the presence of a plurality of such elements. Moreover, any reference signs do not limit the scope of the claims; the invention can be implemented by means of both hardware and software, and several “means” may be represented by the same item of hardware. Furthermore, the invention resides in each and every novel feature or combination of features.

The invention can be summarized as follows. The invention relates to a system comprising an information carrier having an optical identifier, and an apparatus, wherein the apparatus prior to accessing the information carrier verifies if the optical behavior of the optical identifier is consistent with authentication information present in the information carrier. The authentication is performed by challenging the optical identifier with at least one light beam, detecting a resulting speckle pattern on a detector as a corresponding response, and comparing it with the authentication information. Access to the information carrier can be made conditional to a successful authentication, in particular by encrypting user-information present in the information carrier, and thereby providing a strong copy protection scheme. The invention can be applied for example to optical disks or smart cards. The invention further relates to the information carrier, the apparatus, a method for the authentication and a computer program.

1. A system comprising an information carrier (11) for comprising user-information (20) and an apparatus (10) for accessing the information carrier, the information carrier comprising an optical identifier (12) representing a physical one-way function and authentication information (17), the apparatus comprising:
a light source (13) for challenging the optical identifier, when the information carrier is present in the apparatus, by generating a light beam (14) incident on the optical identifier as a challenge,
a detector (15) for detecting as response a speckle pattern (16) produced by the optical identifier upon being challenged with the light beam,
a reading unit (18) for reading the authentication information, and
a verification unit (19) for comparing the response with the authentication information, the authentication information being related to the response.

2. A system as claimed in claim 1 wherein the user-information (20) present in the information carrier (11) is encrypted, and in the apparatus (10):
the reading unit (18) is further capable of reading the user-information,
a decryption key extraction unit (25) is present, for extracting a decryption key from the response, and
a decryption unit (26) is present, for decrypting the user-information encrypted with the decryption key.

3. A system as claimed in claim 1, wherein:
the apparatus (10) is able to provide a set of challenges, the challenges giving rise to corresponding responses, and to detect the corresponding responses,
the authentication information (17) is further related to the corresponding responses, and
the verification unit (19) is able to compare the corresponding responses with the authentication information.

4. A system as claimed in claim 3, wherein the apparatus (10) is able to select a subset of challenges from the set of challenges, to challenge the optical identifier (12) with challenges belonging to the subset of challenges, and to detect a subset of corresponding responses.

5. A system as claimed in claim 3, wherein the authentication information (17) is further related to the set of challenges.

6. A system as claimed in claim 5, wherein the authentication information (17) is in the form of a table (30) having a record (31) for each challenge belonging to the set of different challenges, the record having in a first field (32) the result of a first one-way function applied to the each challenge, and in a second field (33) the result of a second one-way function applied to the corresponding response.

7. A system as claimed in claim 6, wherein the verification unit (19) is able to execute, for the each challenge, the following steps:
applying the first one-way function to the each challenge to obtain a first result,
applying the second one-way function to the corresponding response to obtain a second result,
identifying a record (31) in the table (30) having in the first field (32) a value equal to the fist result, and
reading from the record (31) identified the value present in the second field (33), and comparing it with the second result.

8. A system as claimed in claim 1, wherein the apparatus (10) comprises means for monitoring a time (27) elapsing between challenging the optical identifier (12) and detecting the speckle pattern (16).

9. An information carrier (11) for comprising user-information (20), the information carrier comprising an optical identifier (12) representing a physical one-way function which is able to produce a speckle pattern (16) as a response upon being challenged with a light beam (14) as a challenge, and further comprising authentication information (17) related to the response.

10. An information carrier (11) as claimed in claim 9, wherein the user-information (20) is encrypted and is decryptable with a decryption key extractable from the response.

11. An apparatus (10) for accessing an information carrier (11) for comprising user-information (20), which information carrier comprises an optical identifier (12) representing a physical one-way function and authentication information (17), comprising:
a light source (13) for challenging the optical identifier with a light beam (14) as a challenge,
a detector (15) for detecting a speckle pattern (16) produced by the optical identifier as a response upon being challenged with the light beam,
a reading unit (18) for reading the authentication information, and
a verification unit (19) for comparing the response with the authentication information, the authentication information being related to the response.

12. A method for accessing an information carrier (11) for comprising user-information, which information carrier comprises an optical identifier (12) representing a physical one-way function and authentication information (17), comprising:
a challenging step (42), for challenging the optical identifier with a light beam (14) as a challenge,
a detecting step (43), for detecting a speckle pattern (16) produced by the optical identifier as a response upon being challenged with the light beam,
a reading step (41), for reading the authentication information, and
a verification step (44), for comparing the response and the authentication information, the authentication information being related to the response.

13. A computer program for carrying out the method claimed in claim 12.
